(19) United States
(12) Patent Application Publication
(10) Pub. No.: US 2015/0281548 A1
(43) Pub. Date: Oct. 1, 2015

(54) Surveillance Controlling System

(71) Applicant: Amaryllo International, Inc., Zhubei City (TW)

(72) Inventor: Chao-Tung Yang, Zhubei City (TW)

(21) Appl. No.: 14/311,120

(22) Filed: Jun. 20, 2014

(30) Foreign Application Priority Data
Mar. 31, 2014 (TW) 103112000

(51) Int. Cl. H04N 5/232; H04N 7/18

(52) U.S. Cl. CPC H04N 5/23203; H04N 7/183; H04N 5/23216

(57) ABSTRACT

A surveillance controlling system comprises a controlling device and a surveillance device, the controlling device is provided with a privacy activating button triggered to generate and output a privacy activation controlling signal, the surveillance device is signally connected to the controlling device and is provided with a rotatable camera, when the privacy activation controlling signal is received by the surveillance device, the camera is to automatically rotate to face toward a predetermined privacy protecting position from an original photographing position, accordingly, the problem of privacy in the prior art is solve.

### RELATED APPLICATIONS

This application claim priority to and benefit of Taiwan Patent Application No. 103112000, filed Mar. 31, 2014, entitled “Surveillance Controlling System”, which is incorporated herein by reference.

### FIELD OF THE INVENTION

The present invention relates to a surveillance system, and more particularly to a surveillance controlling system.

### BACKGROUND OF THE INVENTION

With the popularity of the Internet, a surveillance system has been developed having the capability of real-time monitoring through the Internet. By means of the connection via the Internet, a user can observe a remote surveillance image acquired by the surveillance device from anywhere.

Even though the remote monitoring of the surveillance system through remote connection brings convenience, it also causes an issue of privacy-leakage. In other words, with remote monitoring, there is possibility that the privacy surveillance image may be leaked through the Internet as long as the surveillance system has the network transmission function. For example, when the real-time monitoring is processed, the privacy surveillance image may be leaked through the Internet immediately or the privacy surveillance image file may be recorded and distributed through the Internet. Hence, because the surveillance system is applicable in the Internet, it is necessary to provide a solution to solve the problem that the privacy surveillance image acquired by the network-base surveillance system may be leaked through the Internet.

### SUMMARY OF THE INVENTION

Accordingly, an embodiment of the disclosure concerns providing a surveillance controlling system, by which the surveillance device is capable of preventing the privacy image from leakage during a period of time while a user wants to maintain privacy. Accordingly, since there are no privacy surveillance images to be leaked, the problem of privacy in the prior art is solved.

According to an embodiment, the present disclosure provides a surveillance controlling system, comprising: a controlling device being provided with a privacy activating button, wherein the privacy activating button is triggered to generate and output a privacy activation controlling signal; and a surveillance device, which is signally connected to the controlling device and is provided with a rotatable camera, wherein when the privacy activation controlling signal is received by the surveillance device, the camera automatically rotates to face toward a predetermined privacy protecting position from an original photographing position.

According to an aspect of the present disclosure, after the camera rotates to the privacy protecting position for a predetermined period of time, the camera will rotate back to the original photographing position.

According to an aspect of the present disclosure, when the privacy activating control signal is received by the surveillance device, the surveillance device rejects any connection requests from any devices other than the controlling device during a predetermined period of time.

According to an aspect of the present disclosure, a direction of the camera for facing toward the privacy protecting position is opposite to a direction of the camera for facing toward the original photographing position.

According to an aspect of the present disclosure, wherein an angle between a direction of the camera for facing toward the privacy protecting position and a direction of the camera for facing toward the original photographing position is an acute angle or a right angle.

According to an aspect of the present disclosure, the privacy activating button is a software-based virtual button.

According to an aspect of the present disclosure, the privacy activating button is a physical button.

According to an aspect of the present disclosure, the controlling device and the surveillance device are connected via wireless signals.

According to an aspect of the present disclosure, the controlling device is a smart mobile device.

During a period of time while a user intends the surveillance device to not capture a privacy place for privacy protection, the camera of the surveillance device can be immediately rotated to face toward a position where the privacy will not be captured (such as a place opposite to the original photographing position) by means of triggering the privacy activating button of the controlling device by a user, so that the privacy leakage can be more protected. Thereafter, enabling a user to be free from worrying about unexpected situations such as forgetting to turn off the device, the device not being completely turned off, or undesired sharing of network images.

### BRIEF DESCRIPTION OF THE DRAWINGS

FIG. 1 is a schematic diagram illustrating a surveillance controlling device of an embodiment in the present invention;

FIG. 2 is a block diagram illustrating the surveillance controlling device of the embodiment the present invention; and

FIGS. 3A to 3C are schematic diagrams illustrating rotation of a camera of the surveillance controlling device according one embodiment of the present invention.

### DETAILED DESCRIPTION OF THE PREFERRED EMBODIMENTS

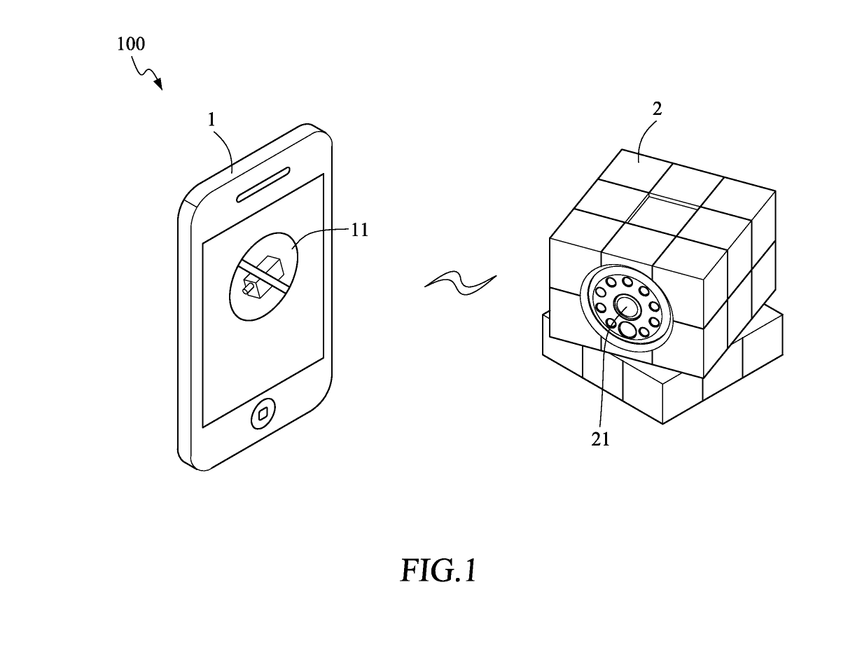

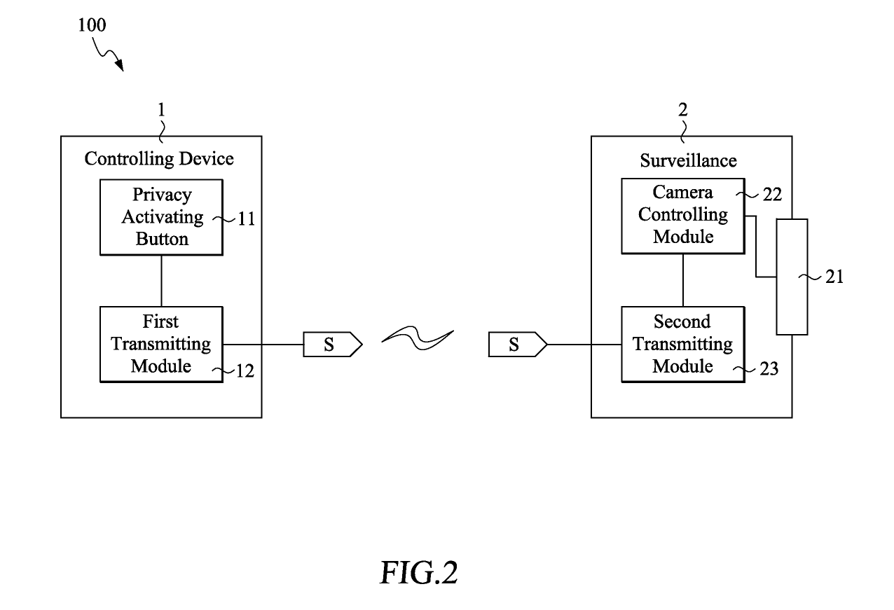

Embodiments are described in detail below with reference to FIG. 1 to FIG. 3C, and the description is used for explaining the embodiments of the present invention only but not for limiting the scope of the claims.

As shown in FIG. 1 to FIG. 3C, a surveillance controlling system 100 according to an embodiment of the present invention comprises: a controlling device 1 being provided with a privacy activating button 11, wherein the privacy activating button 11 is triggered to generate and output a privacy activation controlling signal S; and a surveillance device 2, which is signally (e.g. wirelessly) connected to the controlling device 1 and is provided with a rotatable camera 21, wherein when the privacy activation controlling signal S is received by the surveillance device 2, the camera 21 is to automatically rotate to face toward a predetermined privacy protecting position from an original photographing position.

In this embodiment, the controlling device 1 is a smart mobile device, for example, a smart phone, and the privacy activating button 11 is a software-based virtual button. However, the present invention is not limited to this, while the controlling device 1 also can be a computer or a remote controller and the privacy activating button 11 is not limited to the software-based virtual button but may also be a physical button. Specifically, the controlling device 1 includes a first transmitting module 12 for transmitting the privacy activation controlling signal S. The surveillance device 2 includes a camera controlling module 22 and a second transmitting module 23 for receiving the privacy activation controlling signal S from the controlling device 1. The privacy protecting position of the surveillance device 2 is a position that can be predetermined by a user or can be a default position determined in the factory. Generally, the privacy protecting position and an original photographing position where the camera 21 normally faces toward to capture images can be arranged with a different capturing angle or a distance apart in a way that the image of the photographing position will not be photographed if the camera 21 rotates to face toward the predetermined privacy protecting position. That is, the privacy image concerns an image that the user does not want to be exposed and thus will not be taken by the camera 21.

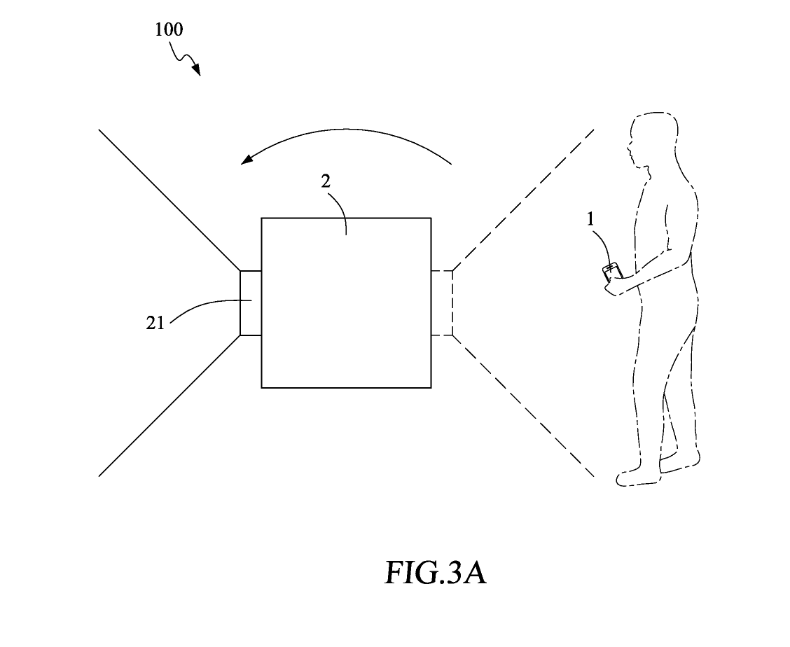

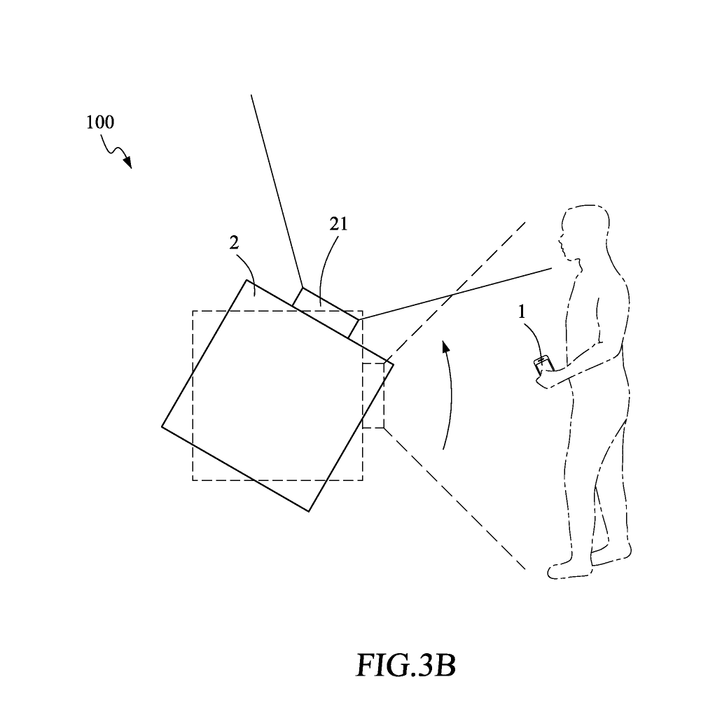

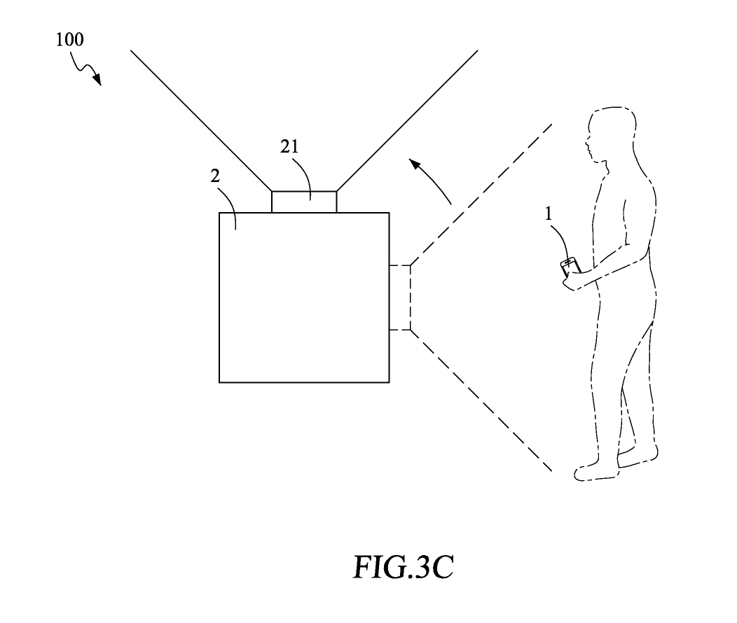

The several predetermined relationships between the privacy protecting position and the photographing position will be described as examples as follows. As shown in FIG. 3A, the relationship between the photographing position and the privacy protecting position is that the direction of the camera 21 for facing toward the privacy protecting position is toward a direction opposite to a direction of the camera 21 for facing toward the normal photographing position. That is, in this example, when a user triggers the privacy activating button, the camera 21 will immediately and automatically rotate to face toward the privacy protecting position, e.g., facing toward the wall, from the original photographing position, the photographing position being opposite to the privacy protecting position, e.g., facing toward the user. This example is suitable to a surveillance 2 having a camera 21 with 360 degree of horizontal rotating angle in which the camera 21 has no blind spot. However, in the case that the rotatable angle camera 21 has a limited rotating angle, as shown in FIGS. 3B and 3C, the privacy protecting position can be set to a position that an angle between a direction of the camera for facing toward the privacy protecting position and a direction of the camera for facing toward the original photographing position is an acute angle, a right angle, or an obtuse angle. In other words, when a user triggers the privacy activating button 11, the camera 21 will immediately and automatically rotate an angle from the original photographing direction of the photographing position by, for example, rotating an acute angle counterclockwise to avoid capturing images of user, as shown in FIG. 3B, or by rotating a right angle counterclockwise to avoid capturing images of user, as shown in FIG. 3c. As a result, no privacy image located at the original photographing position will be photographed by the camera 21 but only the image located at the privacy protecting position is captured, so that the unintended images of a user will not be captured to thus protect the privacy. Even though the privacy image of the camera 21 illustrated in FIGS. 3A to 3C is a person, the privacy image can be configured as the camera 21 facing toward a room, a window, or any other place in which the privacy image may not be a person.

Further, regarding the signal connection between the surveillance device 2 and the controlling device 1, in this embodiment, the controlling device 1 is signally connected to the surveillance device 2 in a wireless manner, for example, by a wireless network or by a directly wireless communication of infrared ray, Bluetooth and so on. However, the present invention is not limited to this, and the controlling device may be signally connected by a physical wire.

According to an embodiment, the surveillance device may further be configured for allowing the camera 21 to be rotated back to the original photographing position after the camera 21 is rotated to the privacy protecting position for a predetermined period of time. The predetermined period of time may be 10 minutes, 1 hour or other time period as configured by a user. For example, for a surveillance device 2 for monitoring indoors while a user is not home, a predetermined period of time may be determined as 8 hours, and thereby after the user goes home and triggers the privacy activating button, the camera 21 will automatically rotate to face toward the privacy protecting position from the original photographing position, e.g., the camera is rotated to photograph the entrance and outside of the house rather than inside of the house, and the camera 21 will be rotated back to the original photographing position 8 hours later. As a result, the camera 21 will not photograph the image when the user is at home, so as to prevent the privacy leakage for a user.

Moreover, in another embodiment, when the privacy activation controlling signal S is received by the surveillance device 2, the surveillance device 2 will reject all connection requests form devices other than the controlling device 1 during a predetermined period of time. That is, even for a user who has an available account and password, for example, a security company or another shared user that has the available account and password, such a user would still not be allowed to access the surveillance device 2 within this predetermined period of time so as to further protect the privacy.

The above description should be considered as only a description of exemplary embodiments of the present invention. However, a person of ordinary skill in the art may make various modifications to the present invention. Those modifications still fall within the spirit and scope defined by the appended claims.

What is claimed is:

1. A surveillance controlling system, comprising:
a controlling device being provided with a privacy activating button, wherein the privacy activating button is triggered to generate and output a privacy activation controlling signal; and
a surveillance device, which is signally connected to the controlling device and is provided with a rotatable camera, wherein when the privacy activation controlling signal is received by the surveillance device, the camera automatically rotates to face toward a predetermined privacy protecting position from an original photographing position.

2. The surveillance controlling system of claim 1, wherein after the camera is rotated to the privacy protecting position for a predetermined period of time, the camera rotates back to the original photographing position.

3. The surveillance controlling system of claim 1, wherein when the privacy activating control signal is received by the surveillance device, the surveillance device rejects any connection requests from any devices other than the controlling device during a predetermined period of time.

4. The surveillance controlling system of claim 1, wherein a direction of the camera for facing toward the privacy protecting position is opposite to a direction of the camera for facing toward the original photographing position.

5. The surveillance controlling system of claim 1, wherein an angle between a direction of the camera for facing toward the privacy protecting position and a direction of the camera for facing toward the original photographing position is an acute angle or a right angle.

6. The surveillance controlling system of claim 1, wherein the privacy activating button is a software-based virtual button.

7. The surveillance controlling system of claim 1, wherein the privacy activating button is a physical button.

8. The surveillance controlling system of claim 1, wherein the controlling device and the surveillance device are connected via wireless signals.

9. The surveillance controlling system of claim 1, wherein the controlling device is a smart mobile device.
